(19) United States
(12) Patent Application Publication
(10) Pub. No.: US 2026/0072654 A1
(43) Pub. Date: Mar. 12, 2026

(54) TECHNIQUES FOR EXTRACTING SOURCE CODE FEATURES TO SUPPORT SOURCE CODE RETRIEVAL AND GENERATION

(71) Applicant: NUTANIX, INC., San Jose, CA (US)

(72) Inventors: Aryan SINGHAL, Pleasanton, CA (US); Rajat GHOSH, San Jose, CA (US); Debojyoti DUTTA, Santa Clara, CA (US); Harshil Anil DADLANI, San Jose, CA (US)

(21) Appl. No.: 19/207,862

(22) Filed: May 14, 2025

Related U.S. Application Data
(60) Provisional application No. 63/693,622, filed on Sep. 11, 2024.

(51) Int. Cl. G06F 8/35

(52) U.S. Cl. CPC G06F 8/35

(57) ABSTRACT

Techniques for extracting source code features to support source code retrieval and generation include receiving source code; generating an abstract syntax tree (AST) based upon the source code; aggregating a plurality of nodes of the AST into a code chunk; presenting the code chunk to a large language model (LLM) with at least one prompt based on a type of feature of a language in which the source code is represented; and receiving a summary of the code chunk from the LLM based upon the at least one prompt, wherein the summary summarizes one or more features of the code chunk.

### CROSS-REFERENCE TO RELATED APPLICATIONS

This application claims priority benefit of the United States Provisional Patent Application titled, “LARGE LANGUAGE MODEL ASSISTED CODE PARSING AND SUMMARIZATION FOR ENHANCE CODE SEARCH RETRIEVAL,” filed on Sep. 11, 2024, and having Ser. No. 63/693,622. The subject matter of this related application is hereby incorporated herein by reference.

### BACKGROUND

### Field of the Various Embodiments

Embodiments of the present invention relate generally artificial intelligence and source code generation, and more specifically to techniques for extracting source code features to support source code retrieval and generation.

### Description of the Related Art

In software development, developers often rely on reusing existing code that has been previously used or tested for new projects as opposed to writing new code for each and every task in a given project. Searching for source code modules or snippets that are appropriate for a given task can be a difficult and time-consuming process that might have been better utilized to write code from scratch. Additionally, the code located by a developer may not be appropriate for a given task, leading to the developer having to rewrite or adapt incompatible source code to the task, which wastes developer time and resources. Locating source code that is appropriate for a given task is made difficult due to the lack of adequate documentation of comments in a source code repository.

Additionally, some solutions for searching for source code rely on keyword-based approaches that rely on matching specific keywords in a corpus of source code with a natural language query provided by a developer. Source code that is written in a programming language often involves complex syntactic rules that can be difficult to represent in a way that facilitates retrieval using natural language queries. In some solutions, domain-specific models are trained on code comments, documentation, and discussions. However, these domain-specific models do not generalize well to different codebases and/or different programming languages.

LLMs have demonstrated good proficiency in converting natural language text descriptions to source code when the LLMs have been suitably trained. The LLMs are also often able to demonstrate the multilingual capabilities to generate both syntactically and semantically correct source code in various programming languages. One drawback of these LLM-based approaches is the generation and development of the training datasets needed to train the LLMs in the code generation task. These training datasets need a large corpus of training examples that map between source code and text-based descriptions of the source code. However, such training datasets are not widely available and the use of inadequate training datasets results in the generated source code having many out-of-vocabulary tokens.

Conventional retrieval augmented generation (RAG) has shown some promise in generating natural language text descriptions from source code. However, with many RAG-based systems, a document containing source code is often too large due to the hierarchical structures and complex semantics in the code for the RAG model to process when the RAG model has a limited context window. As a result, these conventional RAG-based models struggle to produced consistently high-quality natural language descriptions of source code. In addition, the conventional RAG-based models yield inconsistent results due to the inherent ambiguity and context dependence of the programming logic in the source code.

As the foregoing indicates, a need exists in the art for techniques that provide for improved techniques for extracting source code features to support source code retrieval and generation.

### SUMMARY

In various embodiments, one or more non-transitory computer-readable media storing instruction that, when executed by one or more processors, cause the one or more processors to perform a method comprising receiving source code; generating an abstract syntax tree (AST) based upon the source code; aggregating a plurality of nodes of the AST into a code chunk; presenting the code chunk to a large language model (LLM) with at least one prompt based on a type of feature of a language in which the source code is represented; and receiving a summary of the code chunk from the LLM based upon the at least one prompt, wherein the summary summarizes one or more features of the code chunk.

Further embodiments provide, among other things, methods and systems for implementing one or more aspects of the disclosed techniques.

At least one technical advantage of the disclosed techniques relative to the prior art is that, with the disclosed techniques, the extraction and summarization of features in source code is improved. The improved extraction and summarization of the features provide for an improved knowledge base that improves the ability of a code retrieval and generation system to generate source code that meets the requirements of code generation queries provided by users. As a result, the generated source code requires less rewriting than source code generated using prior techniques and reduces the time and resource costs used to generate source code. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIGS. 1A-1D are block diagrams illustrating virtualization system architectures configured to implement one or more aspects of the present embodiments; and

FIG. 2 is a block diagram illustrating a computing environment configured to implement one or more aspects of the present embodiments.

FIG. 3 is a process flow illustrating generation of code summary knowledge base entries, according to various embodiments.

FIG. 4 is an example of a template for a prompt, according to various embodiments.

FIGS. 5A-5E are examples of prompts for generating summaries of different source code features, according to various embodiments.

FIG. 6 includes examples of code summaries, according to various embodiments.

FIG. 7 is a process flow illustrating source code retrieval and generation, according to various embodiments.

FIG. 8 is an example of a code generation prompt, according to some embodiments.

FIG. 9 is a flow diagram of method steps for generating knowledge base entries, according to various embodiments.

FIG. 10 is a flow diagram of method steps for retrieving and generating source code, according to various embodiments.

### DETAILED DESCRIPTION

The technical details set forth in Appendix A, attached hereto, enable a person skilled in the art to implement the embodiments contemplated and described herein.

In the following description, various concepts and examples are disclosed that provide more effective techniques for accessing business data using executable code included in authorization identifiers. The numerous specific details set forth will provide artisans with a more thorough understanding of the various embodiments. However, it will be apparent to one skilled in the art that the inventive concepts can be practiced without one or more of these specific details.

### Exemplary Virtualization System Architectures

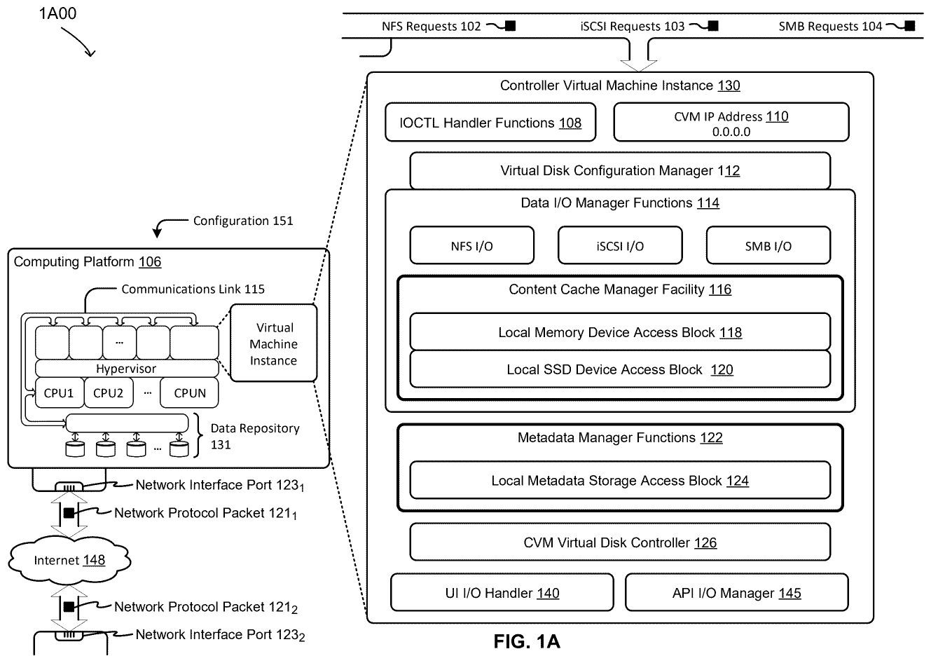

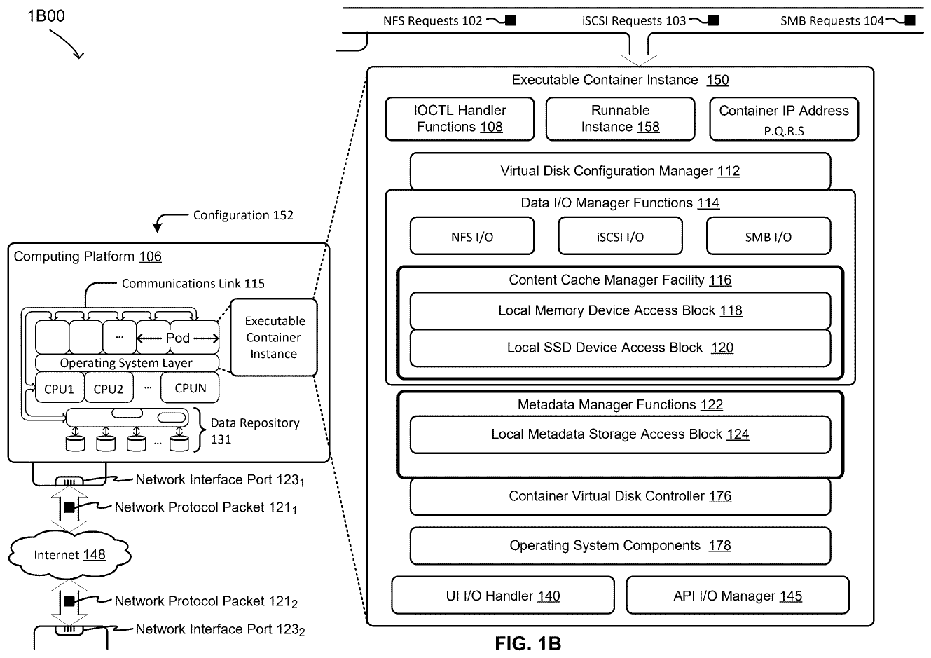

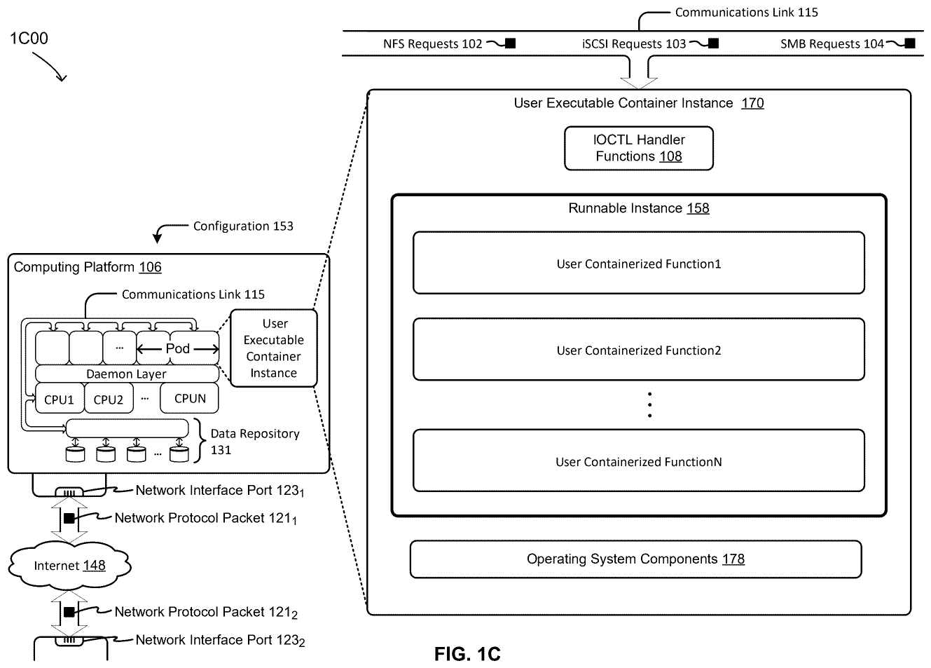

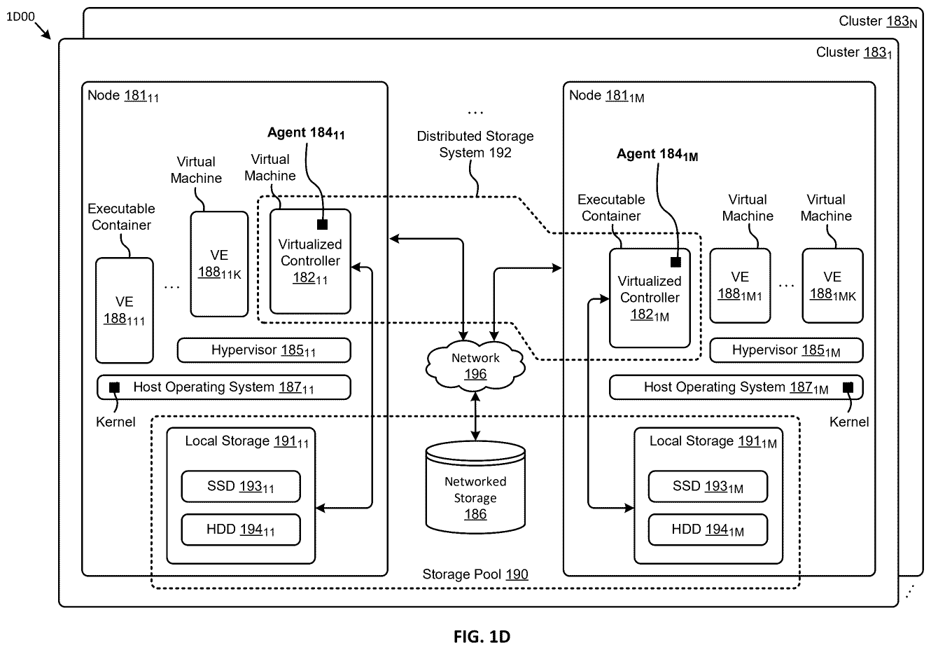

According to some embodiments, all or portions of any of the disclosed techniques can be partitioned into one or more modules and instances within, or as, or in conjunction with a virtualized controller in a virtual computing environment. Some example instances within various virtual computing environments are shown and discussed in further detail in FIGS. 1A-1D. Consistent with these embodiments, a virtualized controller includes a collection of software instructions that serve to abstract details of underlying hardware or software components from one or more higher-level processing entities. In some embodiments, a virtualized controller can be implemented as a virtual machine, as an executable container, or within a layer (e.g., such as a layer in a hypervisor). Consistent with these embodiments, distributed systems include collections of interconnected components that are designed for, or dedicated to, storage operations as well as being designed for, or dedicated to, computing and/or networking operations.

In some embodiments, interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

In some embodiments, a hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

In some embodiments, physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

FIG. 1A is a block diagram illustrating virtualization system architecture 1A00 configured to implement one or more aspects of the present embodiments. As shown in FIG. 1A, virtualization system architecture 1A00 includes a collection of interconnected components, including a controller virtual machine (CVM) instance 130 in a configuration 151. Configuration 151 includes a computing platform 106 that supports virtual machine instances that are deployed as user virtual machines, or controller virtual machines or both. Such virtual machines interface with a hypervisor (as shown). In some examples, virtual machines can include processing of storage I/O (input/output or IO) as received from any or every source within the computing platform. An example implementation of such a virtual machine that processes storage I/O is depicted as CVM instance 130.

In this and other configurations, a CVM instance receives block I/O storage requests as network file system (NFS) requests in the form of NFS requests 102, internet small computer storage interface (iSCSI) block I/O requests in the form of iSCSI requests 103, Samba file system (SMB) requests in the form of SMB requests 104, and/or the like. The CVM instance publishes and responds to an internet protocol (IP) address (e.g., CVM IP address 110). Various forms of input and output can be handled by one or more IO control handler functions (e.g., IOCTL handler functions 108) that interface to other functions such as data IO manager functions 114 and/or metadata manager functions 122. As shown, the data IO manager functions can include communication with virtual disk configuration manager 112 and/or can include direct or indirect communication with any of various block IO functions (e.g., NFS IO, iSCSI IO, SMB IO, etc.).

In addition to block IO functions, configuration 151 supports IO of any form (e.g., block IO, streaming IO, packet-based IO, HTTP traffic, etc.) through either or both of a user interface (UI) handler such as UI IO handler 140 and/or through any of a range of application programming interfaces (APIs), possibly through API IO manager 145.

Communications link 115 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry can be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 106 includes one or more computer readable media that is capable of providing instructions to a data processor for execution. In some examples, each of the computer readable media can take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory (RAM). As shown, controller virtual machine instance 130 includes content cache manager facility 116 that accesses storage locations, possibly including local dynamic random-access memory (DRAM) (e.g., through local memory device access block 118) and/or possibly including accesses to local solid-state storage (e.g., through local SSD device access block 120).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 131, which in turn can be formatted into any one or more storage areas, and which can comprise parameterized storage accessible by a key (e.g., a filename, a table name, a block address, an offset address, etc.). Data repository 131 can store any forms of data and can comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 124. The data repository 131 can be configured using CVM virtual disk controller 126, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU1, CPU2, . . . , CPUN). According to certain embodiments of the disclosure, two or more instances of configuration 151 can be coupled by communications link 115 (e.g., backplane, LAN, PSTN, wired or wireless network, etc.) and each instance can perform respective portions of sequences of instructions as can be required to practice embodiments of the disclosure.

The shown computing platform 106 is interconnected to the Internet 148 through one or more network interface ports (e.g., network interface port 123₁ and network interface port 123₂). Configuration 151 can be addressed through one or more network interface ports using an IP address. Any operational element within computing platform 106 can perform sending and receiving operations using any of a range of network protocols, possibly including network protocols that send and receive packets (e.g., network protocol packet 121₁ and network protocol packet 121₂).

Computing platform 106 can transmit and receive messages that can be composed of configuration data and/or any other forms of data and/or instructions organized into a data structure (e.g., communications packets). In some cases, the data structure includes program instructions (e.g., application code) communicated through the Internet 148 and/or through any one or more instances of communications link 115. Received program instructions can be processed and/or executed by a CPU as it is received and/or program instructions can be stored in any volatile or non-volatile storage for later execution. Program instructions can be transmitted via an upload (e.g., an upload from an access device over the Internet 148 to computing platform 106). Further, program instructions and/or the results of executing program instructions can be delivered to a particular user via a download (e.g., a download from computing platform 106 over the Internet 148 to an access device).

Configuration 151 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT,” issued on Oct. 1, 2013, which is hereby incorporated by reference in its entirety.

FIG. 1B depicts a block diagram illustrating another virtualization system architecture 1B00 configured to implement one or more aspects of the present embodiments. As shown in FIG. 1B, virtualization system architecture 1B00 includes a collection of interconnected components, including an executable container instance 150 in a configuration 152. Configuration 152 includes a computing platform 106 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node can communicate directly with storage devices on the second node.

The operating system layer can perform port forwarding to any executable container (e.g., executable container instance 150). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and can include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is” or “Is -a”, etc.). The executable container might optionally include operating system components 178, however such a separate set of operating system components need not be provided. As an alternative, an executable container can include runnable instance 158, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 176. Such a container virtual disk controller can perform any of the functions that the aforementioned CVM virtual disk controller 126 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 1C is a block diagram illustrating virtualization system architecture 1C00 configured to implement one or more aspects of the present embodiments. As shown in FIG. 1C, virtualization system architecture 1C00 includes a collection of interconnected components, including a user executable container instance in configuration 153 that is further described as pertaining to user executable container instance 170. Configuration 153 includes a daemon layer (as shown) that performs certain functions of an operating system.

User executable container instance 170 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 158). In some cases, the shown operating system components 178 comprise portions of an operating system, which portions are interfaced with or included in the runnable instance and/or any user containerized functions. In some embodiments of a daemon-assisted containerized architecture, computing platform 106 might or might not host operating system components other than operating system components 178. More specifically, the shown daemon might or might not host operating system components other than operating system components 178 of user executable container instance 170.

In some embodiments, the virtualization system architecture 1A00, 1B00, and/or 1C00 can be used in any combination to implement a distributed platform that contains multiple servers and/or nodes that manage multiple tiers of storage where the tiers of storage might be formed using the shown data repository 131 and/or any forms of network accessible storage. As such, the multiple tiers of storage can include storage that is accessible over communications link 115. Such network accessible storage can include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 151) to manage the interactions between the underlying hardware and user virtual machines or containers that run client software.

Distinct from user virtual machines or user executable containers, a special controller virtual machine (e.g., as depicted by controller virtual machine instance 130) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 1D is a block diagram illustrating virtualization system architecture 1D00 configured to implement one or more aspects of the present embodiments. As shown in FIG. 1D, virtualization system architecture 1D00 includes a distributed virtualization system that includes multiple clusters (e.g., cluster 183₁, . . . , cluster 183_{N}) comprising multiple nodes that have multiple tiers of storage in a storage pool. Representative nodes (e.g., node 181₁₁, . . . , node 181_{1M}) and storage pool 190 associated with cluster 183₁ are shown. Each node can be associated with one server, multiple servers, or portions of a server. The nodes can be associated (e.g., logically and/or physically) with the clusters. As shown, the multiple tiers of storage include storage that is accessible through a network 196, such as a networked storage 186 (e.g., a storage area network or SAN, network attached storage or NAS, etc.). The multiple tiers of storage further include instances of local storage (e.g., local storage 191₁₁, . . . , local storage 191_{1M}). For example, the local storage can be within or directly attached to a server and/or appliance associated with the nodes. Such local storage can include solid state drives (SSD 193₁₁, . . . , SSD 193_{1M}), hard disk drives (HDD 194₁₁, . . . , HDD 194_{1M}), and/or other storage devices.

As shown, any of the nodes of the distributed virtualization system can implement one or more user virtualized entities (e.g., VE 188¹¹¹, . . . , VE 188^{11K}, . . . , VE 188^{1M1}, . . . , VE 188^{1MK}), such as virtual machines (VMs) and/or executable containers.

The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 187¹¹, . . . , host operating system 187^{1M}), while the VMs run multiple applications on various respective guest operating systems. Such flexibility can be facilitated at least in part by a hypervisor (e.g., hypervisor 185¹¹, . . . , hypervisor 185^{1M}), which hypervisor is logically located between the various guest operating systems of the VMs and the host operating system of the physical infrastructure (e.g., node).

As an alternative, executable containers can be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers.

Such executable containers directly interface with the kernel of the host operating system (e.g., host operating system 187₁₁, . . . , host operating system 187_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 190 by the VMs and/or the executable containers.

Multiple instances of such virtualized controllers can coordinate within a cluster to form the distributed storage system 192 which can, among other operations, manage the storage pool 190. This architecture further facilitates efficient scaling in multiple dimensions (e.g., in a dimension of computing power, in a dimension of storage space, in a dimension of network bandwidth, etc.).

In some embodiments, a particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 181₁₁ can interface with a controller virtual machine (e.g., virtualized controller 18211) through hypervisor 185₁₁ to access data of storage pool 190. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 192. For example, a hypervisor at one node in the distributed storage system 192 might correspond to software from a first vendor, and a hypervisor at another node in the distributed storage system 192 might correspond to a second software vendor. As another virtualized controller implementation example, executable containers can be used to implement a virtualized controller (e.g., virtualized controller 182_{1M}) in an operating system virtualization environment at a given node. In this case, for example, the virtualized entities at node 181_{1M} can access the storage pool 190 by interfacing with a controller container (e.g., virtualized controller 182_{1M}) through hypervisor 185_{1M} and/or the kernel of host operating system 187_{1M}.

In some embodiments, one or more instances of an agent can be implemented in the distributed storage system 192 to facilitate the herein disclosed techniques. Specifically, agent 184₁₁ can be implemented in the virtualized controller 182₁₁, and agent 184_{1M} can be implemented in the virtualized controller 182_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or the agents.

### Generating Source Code Summary Entries for a Knowledge Base

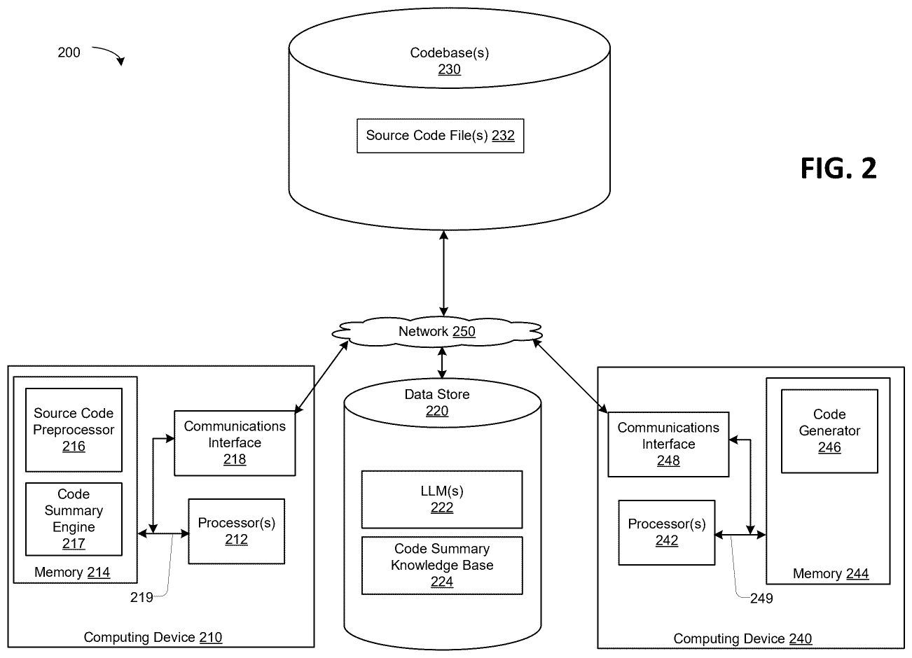

FIG. 2 is a block diagram illustrating a computing environment 200 configured to implement one or more aspects of the present embodiments. As shown, computing environment 200 includes, without limitation, a computing device 210, a data store 220, one or more codebases 230, a computing device 240, and a network 250. Computing device 210 includes, without limitation, one or more processors 212, memory 214, a communications interface 218, and a bus 219. Memory 214 includes, without limitation, a source code preprocessor 216 and a code summary engine 217. Data store 220 includes one or more LLMs 222 and a code summary knowledge base 224. Each of the one or more codebases 230 includes, without limitation, one or more source code files 232. Computing device 240 includes, without limitation, one or more processors 242, memory 244, a communications interface 248, and a bus 249. Memory 244 includes, without limitation, a code generator 246.

Computing environment 200 described herein is illustrative and any other technically feasible configurations fall within the scope of the present disclosure. For example, source code preprocessor 216 and code summary engine 217 can be located and executed in different computing devices. The LLM(s) 222 can be located in a different datastore than code summary knowledge base 224. Further, in the context of this disclosure, any of the computing elements shown in the computing environment 200 can correspond to a physical computing system (e.g., a system in a data center) or can include a virtual computing instance. In various embodiments, the components of the computing environment 200 can be included in any combination of the virtualization system architectures shown in FIGS. 1A-1D.

The one or more processors 212 include any suitable processors implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, the one or more processors 212 can be any technically feasible hardware unit capable of processing data and/or executing software applications.

Memory 214 includes a random-access memory (RAM) module, a flash memory unit, and/or any other type of memory unit or combination thereof. The one or more processors 212 and/or communications interface 218 are configured to read data from and write data to memory 214. Memory 214 can further include additional types of storage Memory 214 can further include additional types of storage including, but not limited to. one or more fixed or removable disk drives, HDDs, SSD, NVMes, vDisks, flash memory devices, and/or other magnetic, optical, and/or solid-state storage devices. Memory 214 includes various software programs that include one or more instructions that can be executed by the one or more processors 212 and application data associated with those software programs. As shown, memory 214 includes source code preprocessor 216 and code summary engine 217.

Communications interface 218 includes any technically feasible interface for coupling computing device 210 and the one more processors 212 with network 250. Communications interface 218 can include one more hardware or software components. For example, communications interface can provide an interface that is compliant with one or more wired or wireless Ethernet standards, and/or the like.

Bus 219 interconnects subsystems and devices within computing device 210, such as the one or more processors 212, memory 214, and communications interface 218. Bus 219 can include one more parallel or serial buses.

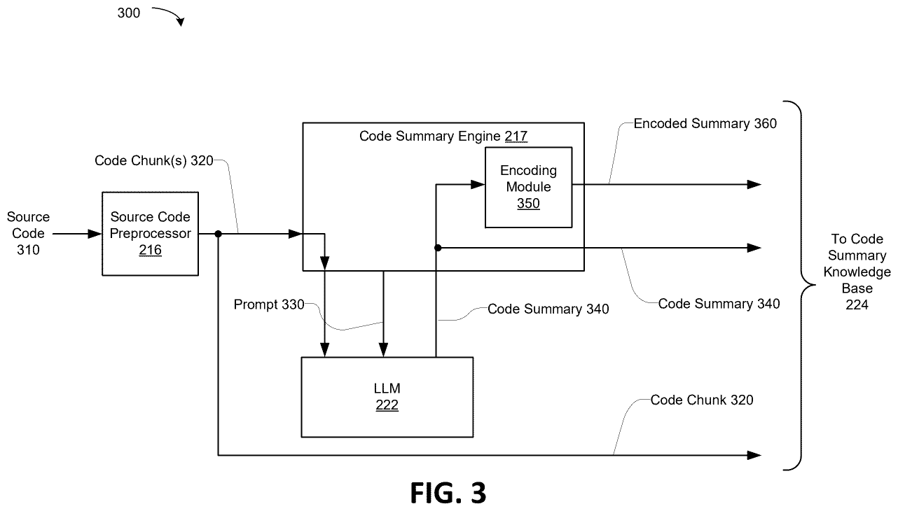

The functionality of source code preprocessor 216 and code summary engine 217 are described with reference to FIG. 3, which is a process flow 300 illustrating generation of code summary knowledge base entries, according to various embodiments. As shown, process flow 300 illustrates, without limitation, how source code preprocessor 216 and code summary engine 217 receive source code 310 and generate one or more entries for storage in code summary knowledge base 224.

Process flow 300 begins with source code preprocessor 216 receiving source code 310. Source code preprocessor 216 can receive source code 310 from any of the one or more source code files 232 and/or the one more codebases 230. For example, a user can specify which source code files 232 and/or codebases 230 are to be summarized. Alternatively, source code preprocessor 216 can receive source code 310 directly from the user, such as via a copy and paste operation. Source code preprocessor 216 then generates an abstract syntax tree (AST) for source code 310. The abstract syntax tree captures the structure of source code 310. Source code preprocessor 216 then traverses the abstract syntax tree to identify semantic components in source code 310. For example, source code preprocessor 216 can traverse the abstract syntax tree in a depth-first fashion. Source code preprocessor 216 uses the identified semantic components to determine source code fragments that are related to each other. Source code preprocessor 216 then aggregates related source code fragments into a code chunk 320. Code chunk 320 is limited in size based on a context limit of an LLM that will be generating a corresponding code summary 340 for code chunk 320. For example, the size of code chunk 320 is limited so that a number of tokens used to encode code chunk 320 and a prompt 330 does not exceed a context limit or a context window of LLM 222. This ensures that code chunk 320 can be fully processed by LLM 222. Source code preprocessor 216 continues to process source code 310 and traverse the abstract syntax tree until all of source code 310 has been aggregated into respective code chunks 320. Source code preprocessor 216 then passes each code chunk 320 to code summary engine 217 for further processing.

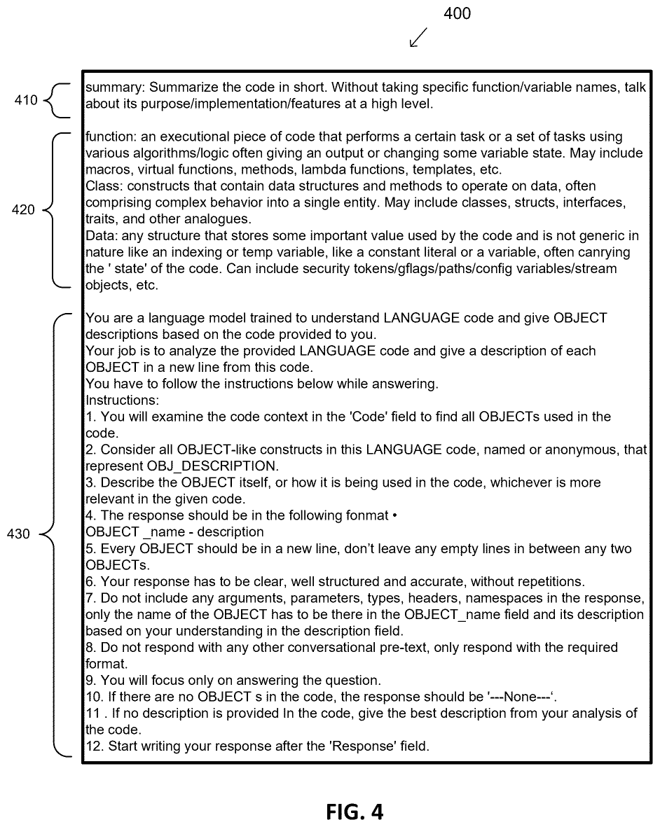

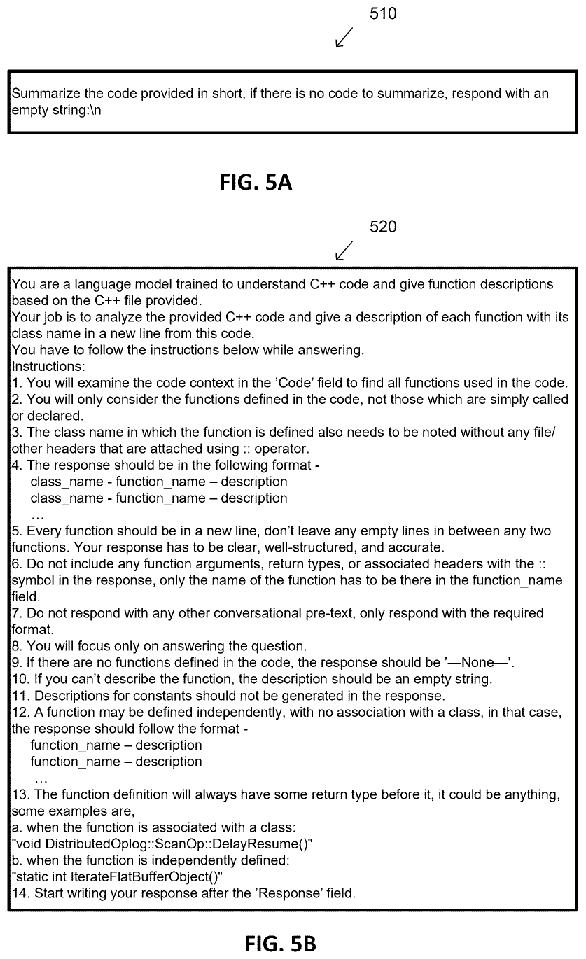

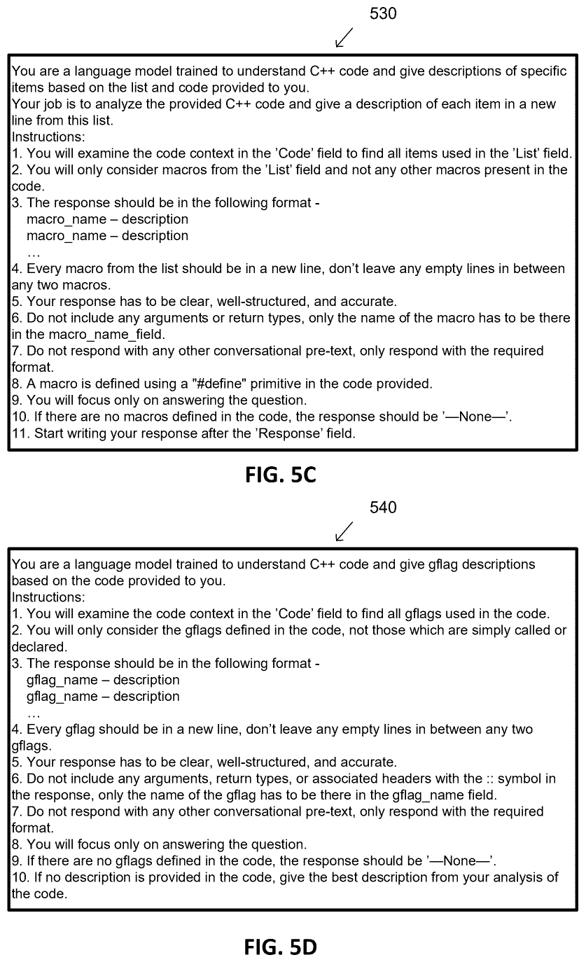

Code summary engine 217 receives each of the one or more code chunks 320 from source code preprocessor 216 and then processes each of the one or more code chunks 320 separately. More specifically, for each code chunk 320, code summary engine 217 presents code chunk 320 and prompt 330 to one of the LLMs 222. Prompt 330 is designed to provide guidance to LLM 222 to generate a code summary 340. Code summary engine 217 can use any of various prompts 330 depending upon a type of code summary 340 that is desired. In some embodiments, code summary engine 217 prompts LLM 222 multiple times for each code chunk 320 in order to generate multiple different summaries of code chunk 320 for storage as respective entries in code summary knowledge base 224. Various examples of prompts suitable for prompt 330 are described in FIGS. 4-5E.

FIG. 4 is an example of a template 400 for a prompt, according to various embodiments. As shown template 400 includes a plurality of sections 410-430. The sections include, without limitation, a summary of instructions 410, a set of definitions 420, and a task specification 430.

Summary of instructions 410 includes a general description of the source code summarization task. This includes express instructions to focus on the purpose, implementation, and/or features of the source code at a high level without reference to specific functions and/or variables names.

The set of definitions 420 provides a definition of various source code elements/entities. The set of definitions 420 includes an expansive definition for a function as a piece of code that performs a task and that can apply to macros, virtual functions, methods, lambda functions, templates, and/or the like. The set of definitions 420 further includes an expansive definition for a class as a construct that contains both data structures and methods and that can apply to classes, structs, interfaces, traits, and other analogues. The set of definitions 420 also includes an expansive definition for data as any structure that stores important values and that can apply to tokens, gflags, paths, config variables, stream objects, and/or the like.

Task specification 430 includes an enumerated lists of instructions that describe the code summary generation task. Task specification 430 is in the form of a template with several placeholders. The placeholders include, without limitation, OBJECT, LANGUAGE, and OBJ_DESCRIPTION. The OBJECT placeholder refers to a type of source code object to summarize, such as a class, function, macro, gflag, enum, service, and/or the like. The LANGUAGE placeholder indicates a programming language, such as C++, Java, Ruby, Python, JavaScript, and/or the like. The OBJ-DESCRIPTION placeholder provides a summary of what is meant by the OBJECT placeholder. In some embodiments, template 400 with the placeholders replaced is suitable for use as prompt 330.

FIG. 5A is an example of a prompt 510 for generating an overall summary of source code, according to various embodiments. As shown, prompt 510 includes a succinct instruction to summarize the source code and to respond with an empty string if no source code is found. In some embodiments, prompt 510 is suitable for use as prompt 330 when an overall summary of code chunk 320 is desired.

FIG. 5B is an example of a prompt 520 for generating a summary of functions in C++ source code, according to various embodiments. As shown, prompt 520 includes a list of task instructions to instruct the LLM about what is meant by a function and how each function is to be summarized including formatting instructions for a response. In some embodiments, prompt 520 is suitable for use as prompt 330 when a summary of functions in a C++ code chunk 320 is desired.

FIG. 5C is an example of a prompt 530 for generating a summary of macros in C++ source code, according to various embodiments. As shown, prompt 530 includes a list of task instructions to instruct the LLM about what is meant by a macro and how each macro is to be summarized including formatting instructions for a response. In some embodiments, prompt 530 is suitable for use as prompt 330 when a summary of macros in a C++ code chunk 320 is desired.

FIG. 5D is an example of a prompt 540 for generating a summary of gfalgs in C++ source code, according to various embodiments. As shown, prompt 540 includes a list of task instructions to instruct the LLM about what is meant by a gflag and how each gflag is to be summarized including formatting instructions for a response. In some embodiments, prompt 540 can be adapted for other parameters that are not glags. In some embodiments, prompt 540 is suitable for use as prompt 330 when a summary of gflags in a C++ code chunk 320 is desired.

FIG. 5E is an example of a prompt 550 for generating a summary of messages, enums, and services in source code, according to various embodiments. As shown, prompt 550 includes a list of task instructions to instruct the LLM about what is meant by a message, enum, or service and how each message, enum, or service is to be summarized including formatting instructions for a response. In some embodiments, prompt 550 is suitable for use as prompt 330 when a summary of messages, enums, and services in a C++ code chunk 320 is desired.

Referring back to FIG. 3, once code summary engine 217 prepares one of template 400 and/or prompts 510, 520, 530, 540, and/or 550, as prompt 330. Code summary engine 217 then presents code chunk 320 and prompt 330 to LLM 222. In some embodiments, code summary engine 217 can append code chunk 320 to prompt 330 before presenting code chunk 320 and prompt 330 to LLM 222. LLM 222 receives code chunk 320 and prompt 330 and generates code summary 340, which corresponds to a summary of code chunk 320 for the code elements requested via prompt 330.

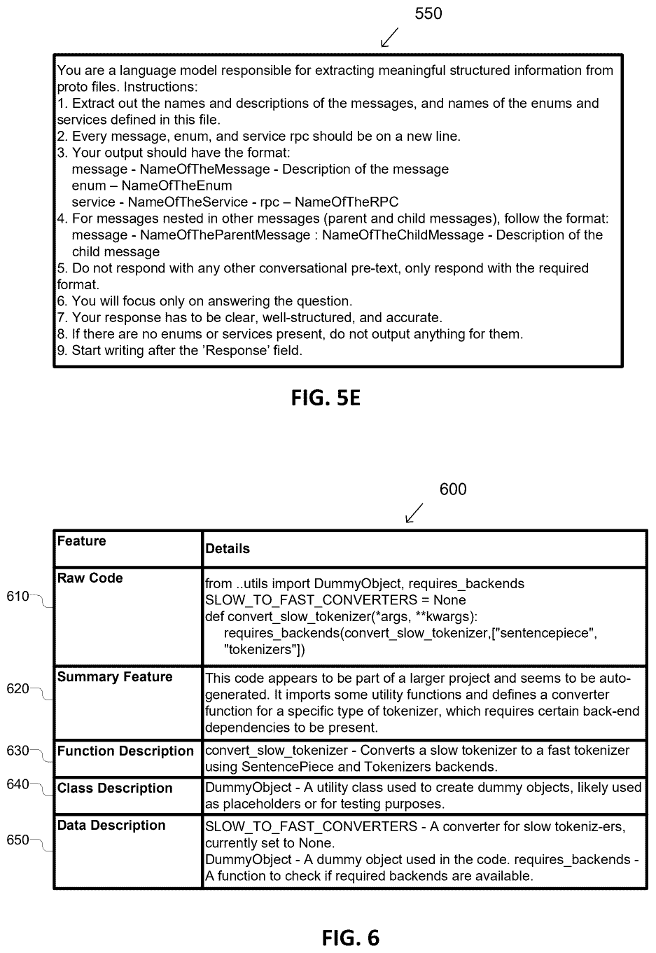

FIG. 6 includes examples of code summaries, according to various embodiments. As shown, examples 600 include, without limitation, raw code 610, a summary feature 620, a function description 630, a class description 640, and a data description 650. Raw code 610 corresponds to the source code that has been summarized. Raw code 610 can correspond to a portion of code chunk 320. Each of summary feature 620, function description 630, class description 640, and data description 650 can be included in a corresponding code summary 340.

Summary feature 620 provides a high-level summary of raw code 610, such as can be generated using prompt 510. Function description 630 provides a summary of the function “convert_slow_tokenizer” found in raw code 610, such as can be generated using prompt 520. Class description 640 provides a summary of the class “DummyObject” found in raw code 610, such as can be generated using a prompt for classes derived from template 400. Data description 650 provides a summary of data objects in raw code 610 (e.g., “SLOW_TO_FAST CONVERTERS” and “DummyObject”), such a can be generated using a prompt for data objects derived from template 400.

Referring back to FIG. 3, code summary engine 217 receives code summary 340 from LLM 222. Code summary engine 217 then encodes code summary 340 using an encoding module 350 to generate an encoded summary 360. Encoding module 350 can be any technically suitable encoding or embedding module, such as the embedding module of any of LLMs 222. Encoded summary 360 efficiently encodes the semantics of code summary 340. Encoded summary 360 also facilitates the comparison of the entries in code summary knowledge base 224 to code generation prompts used to request retrieval and/or generation of source code.

Code summary engine 217 then generates an entry for storage in code summary knowledge base 224. In some embodiments, code summary engine 217 creates the entry as a database table row having fields for code chunk 320, code summary 340, and encoded summary 360. In some embodiments, code summary engine 217 creates the entry as a semi-structured text string with labels and values for each of code chunk 320, code summary 340, and encoded summary 360. Examples of suitable semi-structured text strings include eXtensible Markup Language (XML) strings, JavaScript Object Notation (JSON) strings, and/or the like. Code summary engine 217 then stores the entry in code summary knowledge base 224 for use by code generator 246 as described in further detail below. Code summary engine 217 can store the entry in code summary knowledge base 224 using any technically feasible technique, such as via a database update query, a file write operation, and/or the like.

Referring back to FIG. 2, data store 220 can include any storage device or devices, such as fixed disc drive(s), flash drive(s), optical storage, network attached storage (NAS), and/or a storage area-network (SAN). Although shown as accessible over network 250, in some embodiments computing device 210 can include data store 220. As shown, data store 220 is storing, without limitation, the one or more LLMs 222 and code summary knowledge base 224.

Each of the one more LLMs 222 can include a unimodal large language model that processes a particular one of text, images, audio, video, and/or other inputs, or a multimodal large language model that processes multiple ones of the text, images, audio, video, and/or other inputs. In some examples, an LLM 222 is a zero-shot LLM that has not been trained using labeled datasets with source code and source code summaries. Each LLM 222 can be any technically suitable LLM, such as any of the LLaMa, Mistral, GPT, Phi, and/or similar families of LLMs. For example, the LLM 222 could be DeepSeekCoder-7B-Instruct, Alpaca-7B, LLaMa-2-7B-Chat, Dolly-6B, Vicuna-6B, LLaMa-3-70B-Instruct, LLaMa-3-8B-instruct, LLaMa 30B, Mistral-7B-v0.1, GPT-4o, Pythia 6.9B, Phi-2, and/or the like.

Code summary knowledge base 224 can be any technically feasible storage and organization mechanism. In some embodiments, code summary knowledge base 224 is a SQL or non-SQL database. In some embodiments, code summary knowledge base 224 is a semi-structured file, such as an XML or a JSON file.

Code summary knowledge base 224 includes a large collection of entries (e.g., database rows, XML entries, JSON entries, and/or the like). Each entry includes, without limitation, a code chunk 320, a code summary 340, and an encoded summary 360. Code chunk 320 in an entry is an example of source code that is described by code summary 340. Code summary 340, which is expressed in natural language, facilitates review of the entries in code summary knowledge base 224 by one or more users. Encoded summary 360 in an entry facilities searching of code summary knowledge base 224 for relevant code examples. Code summary knowledge base 224 can further be indexed using the encoded summaries 360 included in the entries. For example, code summary knowledge base 224 can use the encoded summary 360 fields as indexes for a corresponding table in code summary knowledge base 224.

Each of the one or more codebases 230 can correspond to a code repository for a software project, such as a GitHub code repository. Examples of suitable codebases 230 can include, without limitation, python codebases (e.g., HumanEval, Mostly Basic Python Promblems (MBPP), Data Science 1000 (DS-1000), Open-Domain Execution (ODEX), Code Information Retrieval (COIR), Core Evaluation Dataset (CoreFeedback-MT), and CodeTrans-Contest), non-python codebases (e.g., HumanEval-X including C++, Go, Java, and JavaScript source code and CodeSearchNet including Ruby source code), and/or the like.

Each codebase 230 can be stored in any suitable data store, such as in one or more fixed disc drive(s), flash drive(s), optical storage, NASs, and/or SANs. Each codebase 230 can be accessed via an API, such as a web-based API, and/or the like. Each codebase 230 is organized using a directory tree that allows the files stored therein to hierarchically organized. Each codebase 230 includes one or more source code files 232 (e.g., .py, .cc, .cpp, .h, .java, .js, .rb, and/or the like files). As shown, each of the one or more codebases 230 are accessed via network 250, however, any of the codebases 230 could be located in data store 220 and/or in the storage of computing device 210.

The one or more processors 242 include any suitable processors implemented as a CPU, a GPU, an ASIC, a FPGA, an AI accelerator, any other type of processor, or a combination of different processors, such as a CPU configured to operate in conjunction with a GPU. In general, the one or more processors 242 can be any technically feasible hardware unit capable of processing data and/or executing software applications.

Memory 244 includes a RAM module, a flash memory unit, and/or any other type of memory unit or combination thereof. The one or more processors 242 and/or communications interface 248 are configured to read data from and write data to memory 244. Memory 244 can further include additional types of storage. Memory 244 can further include additional types of storage including, but not limited to. one or more fixed or removable disk drives, HDDs, SSD, NVMes, vDisks, flash memory devices, and/or other magnetic, optical, and/or solid-state storage devices. Memory 244 includes various software programs that include one or more instructions that can be executed by the one or more processors 242 and application data associated with those software programs. As shown, memory 244 includes, without limitation, code generator 246.

Communications interface 248 includes any technically feasible interface for coupling computing device 240 and the one more processors 242 with network 250. Communications interface 248 can include one more hardware or software components. For example, communications interface can provide an interface that is compliant with one or more wired or wireless Ethernet standards, and/or the like.

Bus 249 interconnects subsystems and devices within computing device 240, such as the one or more processors 242, memory 244, and communications interface 248. Bus 249 can include one more parallel or serial buses.

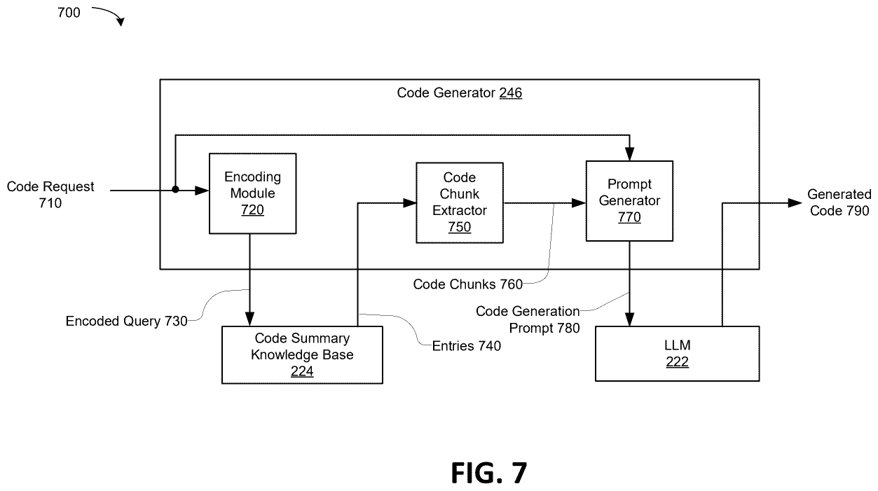

The functionality of code generation 246 is described in detail with reference to FIG. 7, which is a process flow 700 illustrating source code retrieval and generation, according to various embodiments. As shown, process flow 700 illustrates, without limitation, how code generator 246 receives a code request 710 and works with code summary knowledge base 224 and an LLM 222 to retrieve a plurality of code chunks 760 and create generated code 790.

Process flow 700 begins with code generator 246 receiving code request 710. Code request 710 indicates the description for a block of source code that a user would like to generate based on the source code examples and code summaries in code summary knowledge base 224. In some examples, code request 710 includes a request to generate source code for a class having certain types of data structures and certain types of method functionality. In some examples, code request 710 includes a request to generate source code for a function having certain functionality. In some examples, code request 710 includes a request to generate source code for any other type of source code constructs, including data structures, macros, templates, lambda functions, virtual functions, tokens, gflags, paths, config variables, stream objects, and/or the like. Code generator 246 can receive code request 710 using any technically feasible approach including a user typing code request 710, reading a file, extracting code request 710 from a software design document, and/or the like.

Code generator 246 then uses an encoding module 720 to encode code request 710 as encoded query 730. Encoded query 730 includes an efficient encoding of the semantics of code request 710. Encoding module 720 can be any technically suitable encoding or embedding module, such as the embedding module of any of LLMs 222. In some embodiments, encoding module 720 is the same as encoding module 350 so that encoded query 730 and the encoded summaries 360 are encoded using a same token set, which facilitates the use of encoded query 730 to retrieve similar entires 740 from code summary knowledge base 224.

Code generator 246 then uses encoded query 730 to search for entries in code summary knowledge base 224 whose encoded summary 360 best match to encoded query 730. More specifically, code generator 246 uses a similarity or distance measure to determine the difference between encoded query 730 and each of the encoded summaries 360. For example, code generator 246 can use the L₂-Norm to determine a distance between encoded query 730 and an encoded summary 360. Code generator 246 then retrieves the k entries 740 in code summary knowledge base 224 whose encoded summaries 360 are closest in distance or similarity to encoded query 730. Thus, code generator 246 acts as a k-nearest neighbor (k-NN) retriever. Code generator 246 can use any suitable value for k. For example, k could be 2, 3, 4, 5, and/or 6 or more.

Code generator 246 then extracts the code chunk 320 in each of the k-entries 740 as code chunks 760 using a code chunk extractor 750. For example, code chunk extractor 750 can extract a corresponding code chunk 760 from an entry 740 by reading code chunk 760 from the code chunk column of entry 740, reading code chunk 760 from the code chunk tag in the structured text of entry 740 (e.g., the XML or JSON tag), and/or the like.

Code generator 246 then passes the code chunks 760 and code request 710 to prompt generator 770. Prompt generator 770 appends the code chunks 760 and code request 710 to a template prompt to generate a code generation prompt 780. Including the code chunks 760 in code generation prompt 780 provides examples of source code to LLM 222 that are similar to the source code that code generator 246 is being asked to generate.

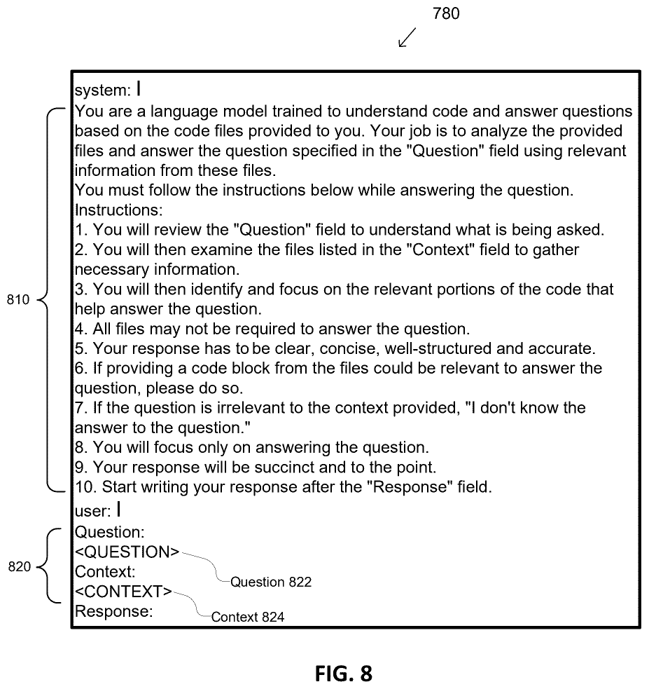

FIG. 8 is an example of a code generation prompt 780, according to some embodiments. As shown, code generation prompt 780 includes, without limitation, a task instruction section 810, and a query section 820. Query section 820 includes, without limitation, a question 822 and a context 824. Task instruction section 810 includes the general task description for code generation. For example, task instruction section 810 describes that an LLM 222 is to generate code that satisfies question 822 subject to the information in context 824. Prompt generator 770 begins building code generation prompt 780 by including task instruction section 810 from the template prompt. Code generator 246 then appends code request 710 to code generation prompt 780 as question 822. Code generator 246 further appends the code chunks 760 to code generation prompt 780 as context 824.

Referring back to FIG. 7, code generator 246 presents code generation prompt 780 to one of the LLMs 222. LLM 222 used by code generator 246 can be the same LLM 222 used by code summary engine 217 or a different one of LLMs 222. LLM 222 processes code generation prompt 780 and returns generated code 790 to code generator 246. Code generator 246 then returns generated code 790 to the user as a response to code request 710. For example, code generator 246 can display generated code on a screen or save generated code to a file. In some embodiments, code generator 246 further returns the code chunks 760 and/or entries 740 to the user to provide examples of source code that are similar to the source code requested via code request 710. Code generator 246 can further receive additional code requests 710 and generate generated code 790 for each of the additional code requests 710.

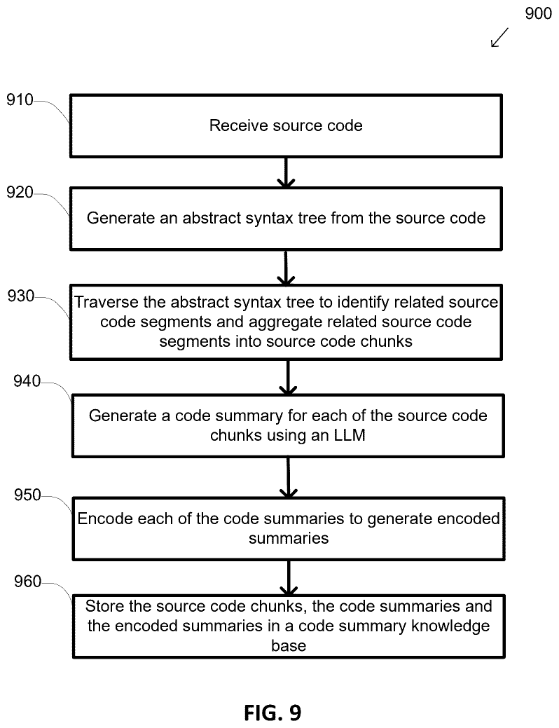

FIG. 9 is a flow diagram of method steps for generating knowledge base entries, according to various embodiments. Although the method steps are described in conjunction with the embodiments of FIGS. 1A-6, persons of ordinary skill in the art will understand that any system configured to perform the method steps, in any order, is within the scope of the invention.

As shown, a method 900 begins at a step 910, where source code preprocessor 216 receives source code 310. Source code preprocessor 216 can receive source code 310 from any of the one or more source code files 232 and/or the one more codebases 230. For example, a user can specify which source code files 232 and/or codebases 230 are to be summarized. Alternatively, source code preprocessor 216 can receive source code 310 directly from the user.

At a step 920, source code preprocessor 216 generates an abstract syntax tree from the source code 310. Source code preprocessor 216 can use any technically feasible to generate the abstract syntax tree. Abstract syntax tree captures the structure of source code 310.

At a step 930, source code preprocessor 216 traverses the abstract syntax tree to identify related source code fragments and aggregates the related source code fragments into code chunks 320. For example, source code preprocessor 216 can traverse the abstract syntax tree in a depth-first fashion to identify the semantic components in source code 310. Source code preprocessor 216 uses the identified semantic components to determine source code fragments that are related to each other. Source code preprocessor 216 then aggregates related source code fragments into code chunks 320. Each code chunk 320 is limited in size based on a context limit of an LLM that will be generating a corresponding code summary 340 for code chunk 320. Source code preprocessor 216 then passes each code chunk 320 to code summary engine 217 for further processing.

At a step 940, code summary engine 217 generates a code summary for each of the source code chunks 330 using an LLM 222. For each code chunk 320, code summary engine 217 presents code chunk 320 and a prompt 330 to the LLM 222. Prompt 330 is designed to provide guidance to LLM 222 to generate a code summary 340. Code summary engine 217 can use any of various prompts 330 including any one of a prompt generated from template 400, one of prompts 510, 520, 530, 540, 550, and/or the like. Code summary engine 217 then receives the code summary 340 generated by LLM 222.

At a step 950, code summary engine 217 encodes each of the code summaries 340 to generate encoded summaries 360. Code summary engine 217 encodes each code summary 340 using an encoding module 350 to generate an encoded summary 360. The encoded summaries 360 facilitate later search for code summaries 340.

At a step 960, code summary engine 217 stores source code chunks 320, code summaries 340, and encoded summaries 360 in code summary knowledge base 224. For each code chunk 320 and corresponding code summary 340 and encoded summary 360, code summary engine 217 generates an entry for storage in code summary knowledge base 224. For example, code summary engine 217 can create each entry as a row for a database table or as a semi-structured text string (e.g., in XML or JSON). Code summary engine 217 then stores the entry in code summary knowledge base 224.

As discussed above and further emphasized here, FIG. 9 is merely an example which should not unduly limit the scope of the claims. One of ordinary skill in the art would recognize many variations, alternatives, and modifications. In some embodiments, method 900 can be repeated additional times for additional source code 310 and/or to summarize different elements or aspects of the same source code 310. In some embodiments, step 940 can be repeated multiple times for a code chunk 320 using different prompts 330 to generate different code summaries 340 for different elements or aspects of code chunk 320. Code summary engine 217 then uses step 950 to encode each of the different code summaries 940 and stores additional entries for each different code summary 940 in code summary knowledge base 224.

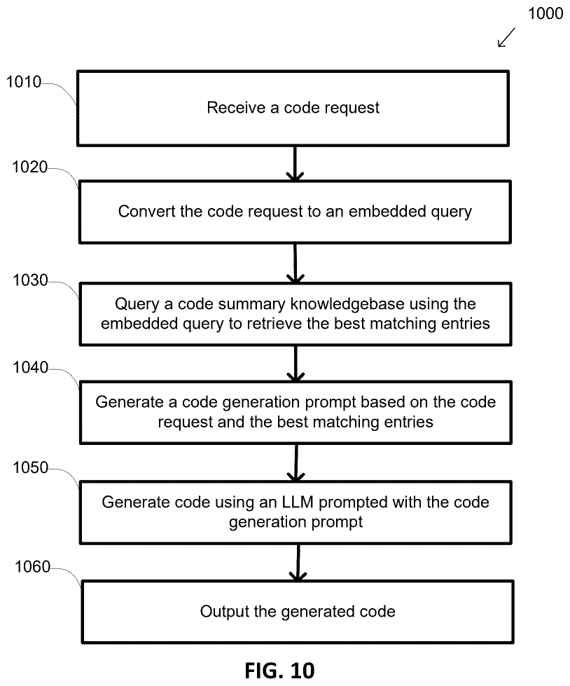

FIG. 10 is a flow diagram of method steps for retrieving and generating source code, according to various embodiments. Although the method steps are described in conjunction with the embodiments of FIGS. 1A-2, 7, and 8, persons of ordinary skill in the art will understand that any system configured to perform the method steps, in any order, is within the scope of the invention.

As shown, a method 1000 begins at a step 1010, where code generator 246 receives a code request 710. Code request 710 indicates the description for a block of source code that a user would like to generate based on the source code examples and code summaries in code summary knowledge base 224. In some examples, code request 710 includes a request to generate source code for a class, a function, a data structure, a macro, a template, a lambda function, a virtual function, a token, a gflag, a path, a config variable, a stream object, and/or the like. Code request 710 further includes a description of the function, structure, and/or the like of the source code to generate. Code generator 246 can receive code request 710 from a user, a file, a software design document, and/or the like.

At a step 1020, code generator 246 converts code request 710 to encoded query 730 using an encoding module 720, such as an embedding module of an LLM 222. Encoded query 730 includes an efficient encoding of the semantics of code request 710.

At a step 1030, code generator 246 queries code summary knowledge base 224 using encoded query 730 to retrieve the best matching entries 740. More specifically, code generator 246 uses a similarity or distance measure to determine the difference between encoded query 730 and each of the encoded summaries 360 stored in the entries of code summary knowledge base 224. For example, code generator 246 can use the L₂-Norm to determine a distance between encoded query 730 and an encoded summary 360. Code generator 246 then retrieves the k entries 740 in code summary knowledge base 224 whose encoded summaries 360 are closest in distance or similarity to encoded query 730.

At a step 1040, code generator 246 generates code generation prompt 780 based on code request 710 and the best matching entries 740. Code generator 246 begins by extracting each of the code chunks 760 from the best matching entries 740 using code chunk extractor 750. Code generator 246 then generates code generation prompt 780 using prompt generator 770. Prompt generator 770 appends code request 710 and the code chunks 760 to task instruction section 810 to generate code generation prompt 780.

At a step 1050, code generator 246 generates generated code 790 using LLM 222 prompted with code generation prompt 780. Code generator 246 presents code generation prompt 780 to LLM 222 and receives the response of LLM 222 as generated code 790.

At a step 1060, code generator 246 outputs generated code 790. Code generator 246 can output generated code 790 to the user on a display, store generated code 790 in a file, and/or the like. In some embodiments, code generator 246 can further output or save the code chunks 760. Method 1000 can then be repeated as many times as desired for different code requests 710 with different generated code 790 being generated for each of the different code requests 710.

In sum, the disclosed techniques support the extracting of source code features to support source code retrieval and generation. The techniques include receiving source code and then generating an abstract syntax tree for the source code. Source code corresponding to a plurality of nodes of the abstract syntax tree are aggregated into a code chunk. The code chunk and a prompt are presented to a large language model. The prompt specifies a type of feature to summarize in the code chunk. A large language model then uses the prompt to generate a summary of features in the code chunk of the specified type. In some embodiments, the techniques further include encoding the summary and then storing the code chunk, the summary, and the encoded summary as an entry in a code summary knowledge base. In some embodiments, the techniques further include receiving a code request, encoding the code request to generate an encoded query, retrieving entries from a knowledge base based on the encoded query, extracting a plurality of code chunks from the retrieved entries, and generating code by presenting the plurality of code chunks and the code request to a second large language model.

At least one technical advantage of the disclosed techniques relative to the prior art is that, with the disclosed techniques, the extraction and summarization of features in source code is improved. The improved extraction and summarization of the features provide for an improved knowledge base that improves the ability of a code retrieval and generation system to generate source code that meets the requirements of code generation queries provided by users. As a result, the generated source code requires less rewriting than source code generated using prior techniques and reduces the time and resource costs used to generate source code. These technical advantages provide one or more technological improvements over prior art approaches.
1. In some embodiments, one or more non-transitory computer-readable media store program instructions that, when executed by one or more processors associated with a first computing device, cause the one or more processors to perform a method comprising receiving source code, generating an abstract syntax tree (AST) based upon the source code, aggregating a plurality of nodes of the AST into a code chunk, presenting the code chunk to a large language model (LLM) with at least one prompt based on a type of feature of a language in which the source code is represented, and receiving a summary of the code chunk from the LLM based upon the at least one prompt, wherein the summary summarizes one or more features of the code chunk.
2. The one or more non-transitory computer-readable media of clause 1, wherein the at least one prompt comprises an instruction to summarize the code chunk.
3. The one or more non-transitory computer-readable media of clauses 1 or 2, wherein the at least one prompt defines the type of feature and provides an instruction to summarize the one or more features of the code chunk corresponding to the type of feature.
4. The one or more non-transitory computer-readable media of any of clauses 1-3, wherein the at least one prompt specifies how the language defines functions, classes, or variables.
5. The one or more non-transitory computer-readable media of any of clauses 1-4, wherein the at least one prompt specifies an output format of the summary.
6. The one or more non-transitory computer-readable media of any of clauses 1-5, wherein a size of the code chunk is based on a size of a context window of the LLM.
7. The one or more non-transitory computer-readable media of any of clauses 1-6, wherein the method further comprises encoding the summary to generate an encoded summary, generating an entry comprising the code chunk, the summary, and the encoded summary, and storing the entry in a knowledge base.

8. The one or more non-transitory computer-readable media of any of clauses 1-7, wherein the entry is an XML string or a JSON string.
9. The one or more non-transitory computer-readable media of any of clauses 1-8, wherein the at least one prompt comprises an instruction to format the summary according to a specified format.
10. The one or more non-transitory computer-readable media of any of clauses 1-9, wherein the method further comprises receiving a code request, encoding the code request to generate an encoded query, retrieving entries from a knowledge base based on the encoded query, extracting a plurality of code chunks from the retrieved entries, and generating code by presenting the plurality of code chunks and the code request to a second LLM.
11. In some embodiments, a computer-implemented method for summarizing source code comprises receiving source code, generating an abstract syntax tree (AST) based upon the source code, aggregating a plurality of nodes of the AST into a code chunk, presenting the code chunk to a large language model (LLM) with at least one prompt based on a type of feature of a language in which the source code is represented, and receiving a summary of the code chunk from the LLM based upon the at least one prompt, wherein the summary summarizes one or more features of the code chunk.
12. The computer-implemented method of clause 11, wherein the at least one prompt comprises an instruction to summarize the code chunk.
13. The computer-implemented method of clauses 11 or 12, wherein the at least one prompt defines the type of feature and provides an instruction to summarize the one or more features of the code chunk corresponding to the type of feature.
14. The computer-implemented method of any of clauses 11-13, wherein the at least one prompt specifies how the language defines functions, classes, or variables.
15. The computer-implemented method of any of clauses 11-14, wherein the at least one prompt specifies an output format of the summary.
16. The computer-implemented method of any of clauses 11-15, wherein a size of the code chunk is based on a size of a context window of the LLM.
17. The computer-implemented method of any of clauses 11-16, wherein the method further comprises encoding the summary to generate an encoded summary, generating an entry comprising the code chunk, the summary, and the encoded summary, and storing the entry in a knowledge base.
18. The computer-implemented method of any of clauses 11-17, wherein the entry is an XML string or a JSON string.
19. The computer-implemented method of any of clauses 11-18, wherein the at least one prompt comprises an instruction to format the summary according to a specified format.
20. The computer-implemented method of any of clauses 11-19, further comprising receiving a code request, encoding the code request to generate an encoded query, retrieving entries from a knowledge base based on the encoded query, extracting a plurality of code chunks from the retrieved entries, and generating code by presenting the plurality of code chunks and the code request to a second LLM.
21. In some embodiments, a system comprises a memory storing instructions, and one or more processors coupled to the memory and, when executing the instructions, are configured to perform operations comprising receiving source code, generating an abstract syntax tree (AST) based upon the source code, aggregating a plurality of nodes of the AST into a code chunk, presenting the code chunk to a large language model (LLM) with at least one prompt based on a type of feature of a language in which the source code is represented, and receiving a summary of the code chunk from the LLM based upon the at least one prompt, wherein the summary summarizes one or more features of the code chunk.
22. The system of clause 21, wherein the at least one prompt comprises an instruction to summarize the code chunk.
23. The system of clauses 21 or 22, wherein the at least one prompt defines the type of feature and provides an instruction to summarize the one or more features of the code chunk corresponding to the type of feature.
24. The system of any of clauses 21-23, wherein the at least one prompt specifies how the language defines functions, classes, or variables.
25. The system of any of clauses 21-24, wherein the at least one prompt specifies an output format of the summary.
26. The system of any of clauses 21-25, wherein a size of the code chunk is based on a size of a context window of the LLM.
27. The system of any of clauses 21-26, wherein the method further comprises encoding the summary to generate an encoded summary, generating an entry comprising the code chunk, the summary, and the encoded summary, and storing the entry in a knowledge base.
28. The system of any of clauses 21-27, wherein the entry is an XML string or a JSON string.
29. The system of any of clauses 21-28, wherein the at least one prompt comprises an instruction to format the summary according to a specified format.
30. The system of any of clauses 21-29, wherein the operations further comprise receiving a code request, encoding the code request to generate an encoded query, retrieving entries from a knowledge base based on the encoded query, extracting a plurality of code chunks from the retrieved entries, and generating code by presenting the plurality of code chunks and the code request to a second LLM. Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing program instructions that, when executed by one or more processors associated with a first computing device, cause the one or more processors to perform a method comprising:
receiving source code;
generating an abstract syntax tree (AST) based upon the source code;
aggregating a plurality of nodes of the AST into a code chunk;
presenting the code chunk to a large language model (LLM) with at least one prompt based on a type of feature of a language in which the source code is represented; and
receiving a summary of the code chunk from the LLM based upon the at least one prompt, wherein the summary summarizes one or more features of the code chunk.

2. The one or more non-transitory computer-readable media of claim 1, wherein the at least one prompt comprises an instruction to summarize the code chunk.

3. The one or more non-transitory computer-readable media of claim 1, wherein the at least one prompt defines the type of feature and provides an instruction to summarize the one or more features of the code chunk corresponding to the type of feature.

4. The one or more non-transitory computer-readable media of claim 1, wherein the at least one prompt specifies how the language defines functions, classes, or variables.

5. The one or more non-transitory computer-readable media of claim 1, wherein the at least one prompt specifies an output format of the summary.

6. The one or more non-transitory computer-readable media of claim 1, wherein a size of the code chunk is based on a size of a context window of the LLM.

7. The one or more non-transitory computer-readable media of claim 1, wherein the method further comprises:
encoding the summary to generate an encoded summary;
generating an entry comprising the code chunk, the summary, and the encoded summary; and
storing the entry in a knowledge base.

8. The one or more non-transitory computer-readable media of claim 7, wherein the entry is an XML string or a JSON string.

9. The one or more non-transitory computer-readable media of claim 1, wherein the at least one prompt comprises an instruction to format the summary according to a specified format.

10. The one or more non-transitory computer-readable media of claim 1, wherein the method further comprises:
receiving a code request;
encoding the code request to generate an encoded query;
retrieving entries from a knowledge base based on the encoded query;
extracting a plurality of code chunks from the retrieved entries; and
generating code by presenting the plurality of code chunks and the code request to a second LLM.

11. A computer-implemented method for summarizing source code, the method comprising:
receiving source code;
generating an abstract syntax tree (AST) based upon the source code;
aggregating a plurality of nodes of the AST into a code chunk;
presenting the code chunk to a large language model (LLM) with at least one prompt based on a type of feature of a language in which the source code is represented; and
receiving a summary of the code chunk from the LLM based upon the at least one prompt, wherein the summary summarizes one or more features of the code chunk.

12. The computer-implemented method of claim 11, wherein the at least one prompt comprises an instruction to summarize the code chunk.

13. The computer-implemented method of claim 11, wherein the at least one prompt defines the type of feature and provides an instruction to summarize the one or more features of the code chunk corresponding to the type of feature.

14. The computer-implemented method of claim 11, wherein the at least one prompt specifies how the language defines functions, classes, or variables.

15. The computer-implemented method of claim 11, wherein the at least one prompt specifies an output format of the summary.

16. The computer-implemented method of claim 11, wherein a size of the code chunk is based on a size of a context window of the LLM.

17. The computer-implemented method of claim 11, wherein the method further comprises:
encoding the summary to generate an encoded summary;
generating an entry comprising the code chunk, the summary, and the encoded summary; and
storing the entry in a knowledge base.

18. The computer-implemented method of claim 17, wherein the entry is an XML string or a JSON string.

19. The computer-implemented method of claim 11, wherein the at least one prompt comprises an instruction to format the summary according to a specified format.

20. The computer-implemented method of claim 11, further comprising:
receiving a code request;
encoding the code request to generate an encoded query;
retrieving entries from a knowledge base based on the encoded query;
extracting a plurality of code chunks from the retrieved entries; and
generating code by presenting the plurality of code chunks and the code request to a second LLM.

21. A system comprising:
a memory storing instructions; and
one or more processors coupled to the memory and, when executing the instructions, are configured to perform operations comprising:
receiving source code;
generating an abstract syntax tree (AST) based upon the source code;
aggregating a plurality of nodes of the AST into a code chunk;
presenting the code chunk to a large language model (LLM) with at least one prompt based on a type of feature of a language in which the source code is represented; and
receiving a summary of the code chunk from the LLM based upon the at least one prompt, wherein the summary summarizes one or more features of the code chunk.

22. The system of claim 21, wherein the at least one prompt comprises an instruction to summarize the code chunk.

23. The system of claim 21, wherein the at least one prompt defines the type of feature and provides an instruction to summarize the one or more features of the code chunk corresponding to the type of feature.

24. The system of claim 21, wherein the at least one prompt specifies how the language defines functions, classes, or variables.

25. The system of claim 21, wherein the at least one prompt specifies an output format of the summary.

26. The system of claim 21, wherein a size of the code chunk is based on a size of a context window of the LLM.

27. The system of claim 21, wherein the method further comprises:
encoding the summary to generate an encoded summary;
generating an entry comprising the code chunk, the summary, and the encoded summary; and
storing the entry in a knowledge base.

28. The system of claim 27, wherein the entry is an XML string or a JSON string.

29. The system of claim 21, wherein the at least one prompt comprises an instruction to format the summary according to a specified format.

30. The system of claim 21, wherein the operations further comprise:
receiving a code request;
encoding the code request to generate an encoded query;
retrieving entries from a knowledge base based on the encoded query;
extracting a plurality of code chunks from the retrieved entries; and
generating code by presenting the plurality of code chunks and the code request to a second LLM.
